(19) United States
(12) Patent Application Publication
(10) Pub. No.: US 2008/0146748 A1
(43) Pub. Date: Jun. 19, 2008

(54) Polyurethane-modified alkyd resin dispersions

(76) Inventors: Harald Blum, Leverkusen (DE); Rolf Gertzmann, Leverkusen (DE); Christoph Irle, Dormagen (DE); Maria Almato Guiteras, Barcelona (ES); Juan Miguel Garcia Martinez, Barcelona (ES)

Correspondence Address: BAYER MATERIAL SCIENCE LLC, 100 BAYER ROAD, PITTSBURGH, PA, 15205, US

(21) Appl. No.: 11/985,494

(22) Filed: Nov. 15, 2007

(30) Foreign Application Priority Data
Nov. 17, 2006 (DE) 102006054237.1

(51) Int. Cl. C08G 63/00

(52) U.S. Cl. 525/418

(57) ABSTRACT

The invention relates to new aqueous polyurethane-modified alkyd resin dispersions, to their preparation and use as binders in paints and coatings.

### CROSS-REFERENCE TO RELATED APPLICATION

This application claims priority under 35 U.S.C. § 119 (a-d) to German application No. DE 10 2006 054 237.1, filed Nov. 17, 2006.

### FIELD OF THE INVENTION

The invention relates to new aqueous polyurethane-modified alkyd resin dispersions containing urethane groups and urea groups, to their preparation and use as binders and paints in coatings.

### BACKGROUND OF THE INVENTION

Known from U.S. Pat. No. 4,116,902 are polyurethane-modified, water-dilutable alkyd resins which incorporate the hydrophilicizing agent dimethylolpropionic acid, condensed into the alkyd resin. No chain extension takes place. A disadvantage here, on the one hand, is the increased susceptibility of the dispersion to hydrolysis, owing to the physical closeness of ester groups and carboxylate groups, and, on the other hand, a not inconsiderable amount of dimethylolpropionic acid being lost to esterification reactions. Moreover, from the present-day viewpoint, the very high level of organic solvents required is unacceptable.

U.S. Pat. No. 5,319,052 discloses special oxidatively crosslinkable urethane resins for printing inks, comprising reaction products of alkyd resins with isocyanates and hydroxycarboxylic acids. The urethane resins have relatively high acid numbers of up to 50 mg KOH/g solid, leading to high water sensitivity when used in coatings.

Owing to the high quantities of high-boiling mineral oils in which the urethane resins are dissolved, the products described are wholly unsuitable in particular for painting and coating applications which require room-temperature drying.

DE-A 199 30 961 describes aqueous polyurethane dispersions which comprise particular transesterification products of castor oil with unsaturated fatty acids or unsaturated oils. These products contain relatively large amounts of semi-drying oils, such as castor oil fatty acid, for example, which make very little contribution, if any, to the oxidative crosslinking.

DE-A 195 02 084 discloses aqueous dispersions based on hydroxy- and carboxy-functional poly(meth)acrylates, fatty acid-modified polyesters and diisocyanates. The products are greatly limited in their oxidative crosslinking capacity, display only averagely good film formation and grain highlighting on wood, and, moreover, are relatively complicated and expensive to prepare. The demand for uncomplicated, inexpensive alkyd resin dispersions for producing high-quality coatings and paints, in particular for wood, furniture, wood-block flooring, wooden window frames and doors, is one which they are unable to cover.

EP-A 0 729 991 describes aqueous polyester-polyurethanes which may optionally also contain groups capable of oxidative drying. A key synthesis component in that case is 1-methyl-2,4 and/or 2,6-diisocyanatohexane. The products are of relatively low molecular mass and additionally comprise organic solvents, in particular NMP and/or xylene, and hence no longer satisfy the present-day requirements. Furthermore, for certain applications, the drying at room temperature is not sufficiently rapid and/or the film hardness is too low.

EP-A 0 379 007 discloses aqueous, oxidatively drying alkyd resin dispersions which, however, are hydroxy-functional and of low molecular mass. No chain extension reaction with diamines and/or polyamines is carried out.

The level of properties is good overall, but the products contain solvent, and corresponding coatings are relatively slow to dry.

EP-A 1 026 186 describes oxidatively drying polyurethane dispersions based on transesterification products of drying oils and low molecular mass polyols, high molecular mass polyols, hydrophilicizing agents containing anionic or cationic groups, and polyisocyanates, and also chain-terminating or chain-extending compounds. The dispersions contain relatively large amounts of NMP and take relatively long to dry.

### SUMMARY OF THE INVENTION

It was an object of the present invention, accordingly, to provide new alkyd resin dispersions which can be prepared easily and from inexpensive raw materials. They ought additionally to be suitable for producing high-quality coatings and paints, in particular for wood, furniture, wood-block flooring, wooden window frames and doors.

This object is achieved through the polyurethane (PU)-alkyd resin dispersions of the invention. The dispersions of the invention can be prepared in such a way as to be almost entirely free from organic solvents, and in particular without N-methyl-pyrrolidone. The alkyd resin dispersions of the invention contain not more than 5%, preferably less than 1%, by weight of organic solvents, and no N-methylpyrrolidone. Furthermore, the alkyd resin dispersions of the invention afford paints and coatings which are distinguished by very good film formation and, in particular, grain highlighting on the substrates, preferably wood and wood-based materials, and which possess outstanding water resistance and ethanol resistance. At the sane time the drying times are approximately 2 hours or less at room temperature and the coatings exhibit film hardness of greater than 75, preferably greater than 100, pendulum seconds and exhibit outstanding black heel mark resistance and a very good relationship between elasticity and hardness.

The percentages given below for the individual components always add up to 100% by weight.

The present invention provides aqueous polyurethane (PU)-alkyd resin dispersions comprising reaction products of
a) at least one alkyd resin incorporating at least 40% by weight of fatty acids capable of oxidative crosslinking with atmospheric oxygen,
b) at least one at least difunctional polyisocyanate,
c) at least one carboxy/carboxylate-functional and hydroxy- or amino-functional hydrophilicizing agent,
d) optionally diols and/or triols of the molecular weight range 62 to 600 and
e) at least one diamine, optionally in combination with a triamine and/or amino alcohol, and
f) optionally other components, different from a) to e).

Methods of preparing the PU-alkyd resin dispersions of the present invention are also provided.

### DETAILED DESCRIPTION OF THE INVENTION

As used herein in the specification and claims, including as used in the examples and unless otherwise expressly specified, all numbers may be read as if prefaced by the word “about”, even if the term does not expressly appear.

Also, any numerical range recited herein is intended to include all sub-ranges subsumed therein.

The aqueous PU-alkyd resin dispersions of the invention feature a ratio of fatty acid groups (MW 280 g/mol) to urethane groups (MW 59 g/mol) of 1:1.5 to 4.5, preferably of 1:2.2 to 3.3.

The alkyd resin a) present as synthesis component in the aqueous PU-alkyd resin dispersions of the invention has an acid number of 6 to 1 mg KOH/g, preferably of 4 to 1.5 mg KOH/g, more preferably of 3 to 2 mg KOH/g and is a reaction product of
a1) at least one dicarboxylic and/or tricarboxylic acid and/or anhydride thereof, preferably a mixture of a11) at least one aromatic dicarboxylic acid and/or its anhydride and a12) at least one linear, aliphatic dicarboxylic acid,
a2) at least one di-, tri- and/or tetraol, preferably at least one triol,
a3) at least one monocarboxylic acid, composed of at least 90%, preferably 100%, by weight of fatty acids containing double bonds capable of oxidative crosslinking with atmospheric oxygen.

The aqueous PU-alkyd resin dispersions of the invention comprise reaction products of 35% to 75%, preferably of 42% to 64%, by weight of component a), of 18% to 46%, preferably of 23% to 40%, by weight of component b), of 2% to 10%, preferably of 2.5% to 5%, by weight of component c), of 0% to 9%, preferably of 1% to 7.5%, by weight of component d), of 0.5% to 7%, preferably of 1% to 5.5%, by weight of component e) and of 0% to 3%, preferably of 0% to 1%, by weight of component f).

The PU-alkyd resin dispersions of the invention have OH contents of 0% to 1.5%, preferably of 0% to 0.5% and more preferably of 0%. The OH contents >0% are exclusively obtained through sole or conjoint use of amino alcohols as chain extender component e).

Component e) of the aqueous PU-alkyd resin dispersions of the invention is preferably composed of an at least linear-aliphatic diamine e1) and at least one cycloaliphatic diamine e2), the amount by weight of the cycloaliphatic diamine e2) being greater than the amount by weight of the linear-aliphatic diamine e1).

The alkyd resin a) preferably comprises the following synthesis components:
a1) 10% to 35%, preferably 15% to 30%, by weight of at least one dicarboxylic and/or tricarboxylic acid and/or anhydride thereof,
a2) 15% to 40%, preferably 20% to 33%, by weight of at least one di-, tri- and/or tetraol and
a3) 44% to 75%, preferably 48% to 68%, by weight of at least one monocarboxylic acid, consisting to an extent of at least 90%, preferably 100%, by weight of fatty acids containing double bonds capable of oxidative crosslinking with atmospheric oxygen.

The alkyd resin a) preferably has a hydroxy-functionality of 1.1 to 2.3, preferably of 2, an OH number of 40 to 130 mg KOH/g, preferably of 50 to 95 mg KOH/g solid, and an acid number of 6 to 1 mg KOH/g, preferably 4 to 1.5 mg KOH/g, more preferably of 3 to 2 mg KOH/g. The alkyd resins a) have average molecular weights of 750 to 5000 g/mol, preferably of 900 g/mol to 2500 g/mol.

With particular preference the alkyd resin a) comprises as synthesis components
a11) 7% to 22% by weight of at least one aromatic dicarboxylic acid and/or its anhydride,
a12) 3% to 15% by weight of at least one linear, aliphatic dicarboxylic acid and
a2) 20% to 33% by weight of at least one triol and
a3) 48% to 68% by weight of at least one fatty acid containing double bonds capable of oxidative crosslinking with atmospheric oxygen,
   the sum of a11) and a12) being 15% to 30% by weight.

The particularly preferred alkyd resins a) here have an OH number of 50 to 95 mg KOH/g solid, with a calculated functionality of 2 and an average molecular weight of 1000 to 2000 g/mol.

In one preferred embodiment the alkyd resin a) contains at least as many equivalents of monocarboxylic acids a3) as there are equivalents of triols a2) present.

The alkyd resin a) is prepared by means of a polycondensation process with elimination of water at reaction temperatures of 100 to 260° C. The reaction can be carried out with the assistance of catalysts, examples being tin-based catalysts such as stannic acid (Fascat® R 4100, Arcema), dibutyltin oxide, dibutyltin dilaurate or tin(II) chloride, or hydrochloric acid, para-toluenesulphonic acid and other esterification catalysts known from the literature. Condensation is continued until an acid number of 6 to 1 mg KOH/g, preferably 4 to 1.5 mg KOH/g, more preferably 3 to 2 mg KOH/g solid has been reached. The use of suitable entrainers, such as toluene, isooctane, nonane, cyclohexane, is possible but not preferred. The reaction can be accelerated by application of vacuum or, preferably, by passing one to three times the reactor volume of nitrogen through the system per hour. Passing nitrogen through is preferred.

Suitable dicarboxylic and/or tricarboxylic acid and/or anhydrides thereof a1), are, for example, phthalic anhydride, isophthalic acid, terephthalic acid, tetrahydrophthalic anhydride, hexahydrophthalic anhydride, cyclohexane dicarboxylic acid, adipic acid, azelaic acid, sebacic acid, glutaric acid, tetrachlorophthalic acid, maleic acid, fumaric acid, itaconic acid, malonic acid, suberic acid, 2-methylsuccinic acid, 3,3-diethylglutaric acid, 2,2-dimethylsuccinic acid, dimer fatty acids, dimer fatty acid mixtures, trimellitic acid, and mixtures of the stated acids and of other acids too.

The proportional, conjoint use of tetracarboxylic acids and/or their anhydrides, such as pyromellitic acid, for example, is another possibility.

Based on a1) it is preferred to use mixtures of 7% to 22% by weight of at least one aromatic dicarboxylic acid and/or its anhydride a11), and 3% to 15% by weight of at least one linear, aliphatic dicarboxylic acid a12).

Preferred components a11) are phthalic anhydride, isophthalic acid, terephthalic acid, tetrahydrophthalic anhydride and/or mixtures thereof.

Preferred components a12) are adipic acid, maleic acid, and/or glutaric acid and/or mixtures thereof.

Particular preference is given to the mixtures of a11) phthalic acid and/or isophthalic acid with a12) adipic acid.

Suitable di-, tri- and/or tetraols a2) are, for example, ethylene glycol, propylene glycol, butylene glycol, diethylene glycol, triethylene glycol, dipropylene glycol, tripropylene glycol, polyalkylene glycols such as polyethylene glycol, 1,4-cyclohexanedimethanol, 1,4-cyclohexanediol, pentanediol, hydrogenated bisphenol A, 1,3-propanediol, 1,4-butanediol, 1,6-hexanediol, neopentyl glycol, neopentyl glycol hydroxypivalate, trimethylolpropane, trimethylolethane, glycerol, erythritol, pentaerythritol, trimethylolbenzene or trishydroxyethylisocyanurate and mixtures thereof.

Preferred components a2) are trimethylolpropane and glycerol, optionally in combination with diethylene glycol or neopentyl glycol.

Suitable monocarboxylic acids a3) are short-chain or aromatic monocarboxylic acids such as, for example, benzoic acid, tert-butylbenzoic acid, hexahydrobenzoic acid or 2-ethylhexanoic acid, monocarboxylic acids which contain constituents having double bonds that are capable of oxidative crosslinking with atmospheric oxygen, examples being soya oil fatty acid, safflower oil fatty acid, tall oil fatty acid, fish oil fatty acid, tung oil fatty acid, linseed oil fatty acid and/or sunflower oil fatty acid, and also semi-drying or non-drying fatty acids such as, for example, castor oil fatty acid, coconut oil fatty acid or peanut oil fatty acid. It is preferred to use exclusively drying fatty acids, such as soya oil fatty acid or sunflower oil fatty acid, for example.

The stated fatty acids capable of oxidative drying, such as soya oil fatty acid, for example, as a general rule, depending on origin and year of harvest, contain mixtures of different, more or less unsaturated fatty acids and also saturated fatty acids, in fluctuating compositions. For simplification, fatty acids of this kind with relatively high fractions of fatty acids capable of oxidative drying are always considered as being 100% capable of oxidative drying—that is, of crosslinking by reaction with atmospheric oxygen. They are then referred to as drying oils or drying fatty acids.

Suitable at least difunctional polyisocyanates b) are, for example, 1,3-cyclohexane diisocyanate, 1-methyl-2,4-diisocyanatocyclohexane, 1-methyl-2,6-diisocyanatocyclohexane, tetramethylene diisocyanate, 4,4′-diisocyanatodiphenylmethane, 2,4′-diisocyanatodiphenylmethane, 2,4-diiso-cyanatotoluene, 2,6-diisocyanatotoluene, α,α,α′,α′-tetramethyl-m- or p-xylylene diisocyanate, 1,6-hexamethylene diisocyanate, 1-isocyanato-3,3,5-trimethyl-5-isocyanatomethylcyclohexane (isophorone diisocyanate) and 4,4′-diisocyanatodicyclohexylmethane, and also mixtures thereof, optionally also with other isocyanates and/or higher polyfunctional homologues and/or oligomers containing urethane, biuret, carbodiimide, isocyanurate, allophanate, iminooxadiazinedione and/or uretdione groups.

The polyisocyanate component b) preferably contains at least 30% to 95% by weight of cycloaliphatic diisocyanates such as isophorone diisocyanate, 1-methyl-2,4(2,6)-diisocyanatocyclohexane, 4,4′-diisocyanatodicyclohexylmethane and 5% to 70% by weight of aromatic di- and/or polyisocyanates such as 2,4(2,6)-diisocyanatotoluene, 4,4′- and/or 2,4′-diisocyanatodiphenylmethane and its homologues.

The conjoint use of linear-aliphatic diisocyanates, such as hexamethylene diisocyanate, for example, in minor amounts, i.e. up to 20% of the overall component b), is possible.

With particular preference the polyisocyanate component b) contains 55% to 95% by weight of isophorone diisocyanate and/or 4,4′-diisocyanatodicyclohexylmethane and 5% to 45% by weight of 2,4(2,6)-diisocyanatotoluene or 4,4′- and/or 2,4′-diisocyanatodiphenylmethane.

Suitable components c) with a hydrophilicizing action are dimethylolpropionic acid, dimethylolbutyric acid, hydroxypivalic acid, and caprolactone adducts with the stated hydroxycarboxylic acids, Michael addition products of diamines such as isophoronediamine or ethylenediamine, for example, with 2 equivalents of acrylic acid. A preferred hydrophilicizing agent is dimethylolpropionic acid. Mixture of different hydrophilicizing agents can also be used.

Before or during the dispersing step, component c) is converted into the corresponding carboxylate by reaction with a neutralizing agent. This is possible in principle before or during the individual process steps in the course of the preparation operations described below.

The degree of neutralization lies between 50% and 140%, preferably at 70% to 110%.

Examples of suitable neutralizing agents include triethylamine, ethyldiisopropylamine, dimethylisopropylamine, dimethylcyclohexylamine, N-methylmorpholine and mixtures thereof.

The pH values of the alkyd resin dispersions of the invention lie between 6 to 10, preferably between 6.5 to 8.2. Higher pH values can lead to instances of discoloration in the case of various types of wood.

The components d) have a molecular weight of 62 to 600 g/mol and are, for example, ethanediol, di-, tri-, tetraethylene glycol, 1,2-propanediol, di-, tri-, tetrapropylene glycol, 1,3-propanediol, butane-1,4-diol, butane-1,3-diol, butane-2,3-diol, pentane-1,5-diol, hexane-1,6-diol, 2,2-dimethyl-1,3-propanediol, neopentyl glycol, hydrogenated bisphenol A, neopentyl glycol hydroxypivalate 1,4-dihydroxycyclohexane, 1,4-dimethylolcyclohexane, octane-1,8-diol, decane-1,10-diol, dodecane-1,12-diol or mixtures thereof, higher polyfunctional polyols such as trimethylolpropane or glycerol and/or mixtures of the stated diols and/or triols, optionally with other diols and/or triols as well. Likewise suitable are diols and/or triols which are reaction products of the exemplified diols and/or triols with ethylene oxide, propylene oxide and/or caprolactone. It is likewise possible to use mixtures of different diols and/or triols d).

Preferred as component d) are low molecular weight diols having a molecular weight of 62 to 142, such as butanediol, hexanediol, neopentyl glycol, ethylene glycol, 1,4-cyclohexanediol and/or 1,4-cyclohexanedimethanol, for example. Particular preference is given to 1,4-butanediol.

Diamines, triamines and amino alcohols e) suitable as chain extenders are ethylenediamine, propylenediamine, 1,2-diaminopropane, 1,4-diaminobutane, 2,5-diamino-2,5-dimethylhexane, 1,5-diamino-2-methylpentane (Dytek®A, DuPont), 1,6-diaminohexane, 2,2,4- and/or 2,4,4-trimethyl-1,6-diaminohexane, 1,11-diaminoundecane, 1,12-diaminododecane, triaminononane, hydrazine, hydrazine hydrate, adipic dihydrazide, diethylenetriamine, higher molecular weight polyetherpolyamines with aliphatically attached primary amino groups, of the kind sold, for example, under the name Jeffamin® by Huntsman, 1-amino-3,3,5-trimethyl-5-aminomethylcyclohexane (IPDA), 2,4- and/or 2,6-hexahydrotolylenediamine(H₆TDA), isopropyl-2,4-diaminocyclohexane and/or isopropyl-2,6-diaminocyclohexane, 1,3-bis(aminomethyl)cyclohexane, 2,4′- and/or 4,4′-diaminodicyclohexylmethane, 3,3′-dimethyl-4,4′-diaminodicyclo-hexylmethane (Laromin® C 260, BASF AG, DE), the isomers, diaminodicyclohexylmethanes containing a methyl group as ring substituent (═C-monomethyl-diaminodicyclohexylmethane), 3(4)-aminomethyl-1-methylcyclohexylamine (AMCA) and also araliphatic diamines, such as 1,3-bis(aminomethyl)benzene, xylylenediamine, amino alcohols such as 2-aminoethanol, aminopropanols, 3-amino-1,2-propanediol, aminobutanols, 1,3-diamino-2-propanol, bis(2-hydroxypropyl)amine and propanolamine 1,1′-dimethyl-1,1′-dipropyl-2,2′-iminodiethanol, 2-(2-hydroxyethyl)amino-2-methylpropan-1-ol, 1-(2-hydroxyethyl)amino-2-propanol and 3,3′-diallyloxy-2,2′-dihydroxydipropylamine, hydroxyethylethylenediamine, bishydroxyethyl-ethylenediamine. Likewise suitable are Michael adducts which are obtained by reacting difunctional primary amines with maleic diesters and are referred to as aspartic esters. Aspartic esters of this kind are described for example in EP-A 403 921. Likewise suitable for conjoint use are monofunctional or difunctional amines additionally containing alkoxysilane groups.

Component e) contains preferably at least 85%, with particular preference 100%, by weight of aliphatic and/or cycloaliphatic diamines.

With particular preference component e) comprises a mixture of at least one linear-aliphatic diamine and/or triamine e1) and at least one cycloaliphatic diamine e2). The amount by weight of the cycloaliphatic diamine e2) is greater than the amount by weight of the linear-aliphatic diamine and/or triamine e1). Preferably the amount of e) is composed of 55% to 90% by weight of e2) and of 10% to 45% by weight of e1).

Preferred linear-aliphatic diamines and/or triamines e1) are ethylenediamine and diethylenetriamine; preferred cycloaliphatic diamines e2) are 1-amino-3,3,5-trimethyl-5-aminomethylcyclohexane (IPDA), 2,4- and/or 2,6-hexahydrotolylenediamine(H₆TDA), 2,4′- and/or 4,4′-diaminodicyclohexylmethane and/or 3,3′-dimethyl-4,4′-diaminodicyclohexylmethane.

With very particular preference component e) is composed of 55% to 90% by weight of 1-amino-3,3,5-trimethyl-5-aminomethylcyclohexane (IPDA) e2) and of 45% to 10% by weight of ethylenediamine e1), optionally in combination with diethylenetriamine.

Other components, components f), are, for example, monohydroxy-functional ethylene oxide polyethers, monohydroxy-functional propylene oxide/ethylene oxide copolyethers and/or monohydroxy-functional propylene oxide/ethylene oxide block polyethers of the molecular weight range 200 to 3000 g/mol, or monoalcohols such as benzyl alcohol or n-butanol, or monoamines such as N-butylamine, for example.

The alkyd resin dispersions of the invention are always prepared via an isocyanate-functional alkyd resin prepolymer precursor, which is obtained by reacting the alkyd resin a) and a hydrophilicizing agent c) and optionally components d) and f) with the isocyanate component b). This reaction may take place in one stage, i.e. by reaction of all the reaction components in one step, or else in a plurality of stages, such as, for example, by reacting a), b), c) and optionally f) in the first reaction step and in a 2nd reaction step reacting this intermediate with component d) to form the isocyanate-functional alkyd resin prepolymer precursor. Also possible are other reaction sequences in the reaction of components a), b), c), d) and optionally f).

The present invention accordingly likewise provides a process for preparing the PU-alkyd resin dispersions of the invention, characterized in that components a) to d) and optionally f) are reacted in one or more reaction steps to give an isocyanate-functional alkyd resin, with solvents and neutralizing agents being added before, during and/or after the reaction, then a chain extension is carried out with component e) in organic solution and subsequently dispersion is carried out in or with water. The solvent is preferably separated off by distillation during or after the dispersing step.

In a further variant of the process of the invention, after the neutralizing operation, dispersion is then carried out in or with water and subsequently a chain extension is carried out with component e) in aqueous dispersion.

In the case of a multi-stage procedure it is also possible to carry out the first stage, where the alkyd resin a), the polyisocyanate c) and optionally the hydrophilicizing component b) are reacted, without solvent, then to add solvent, and to carry out the second stage, the reaction with component d) and, if b) is not already present in the first stage, with b).

In one preferred variant of the process of the invention components a) to d) and optionally f) are reacted in one or more reaction steps to give an isocyanate-functional alkyd resin, with solvents being added before, during or after the reaction and the neutralizing agent being added during or after the reaction, preferably after the reaction, subsequently a first chain extension is carried out with a portion of component e) in organic solution and then a second chain extension is carried out with the remainder of component e), during or after the dispersing step, the quantitative ratio of the components e) used in the first and in the second chain extension steps being 0.3:1 to 6:1.

The solvent is preferably separated off by distillation during or after the dispersing step.

The chain extender component e) is used in amounts of 35% up to a maximum of 90% by weight, preferably of 45% to 75% by weight, based on the NCO content of the isocyanate-functional alkyd resin.

The isocyanate-functional alkyd resin prepolymer precursor is prepared in organic solution with solids contents of 30% to 95% by weight, preferably of 55% to 80% by weight.

Suitable in principle are all solvents which do not react with isocyanate groups and which, at least when mixed with other solvents, exhibit sufficient solvency for the raw materials and/or end products, such as acetone, methyl ethyl ketone, methyl isobutyl ketone, solvent naphtha, toluene, xylene, cyclohexane, methoxypropyl acetate, N-methylpyrrolidone, N-ethylpyrrolidone, diethylene glycol dimethyl ether, dipropylene glycol dimethyl ether, ethylene glycol dimethyl ether or tetramethoxymethane, for example. A preferred solvent is acetone.

The reaction of components a), b), c) and optionally d) can be carried out with or without the addition of substances having a catalytic action. Suitable catalysts are the metal catalysts customary in polyurethane chemistry, such as, for example, tin compounds such as dibutyltin dilaurate, Formrez® UL 29 (tin catalyst; Witco, USA), butyltin oxide, dibutyltin oxide, Fascat® 4100 (tin catalyst, Arkema, France), tin chloride, tin(II) octoate or bismuth octoate, phenylmercury acetate; likewise suitable are amine catalysts such as, for example, triethylamine, diazabicyclononene, diazabicyclooctane, diazabicycloundecene and/or dimethylaminopyridine. The reaction takes place preferably in the presence of catalysts.

Particularly preferred is the use of 25 to 250 ppm of metal catalysts based on the amounts of a), b), c) and optionally d), preferably dibutyltin dilaurate, dibutyltin oxide, tin(II) octoate and bismuth octoate.

The process of the invention is carried out preferably in the presence of drying accelerants based on cobalt, vanadium, manganese, copper, zirconium, calcium and/or zinc compounds. These drying accelerants are preferably added prior to the dispersing step. It is also possible to add drying accelerants after the dispersing step or else not until later, of the stage of formulation of the paint. In these cases the drying accelerants, for greater ease of incorporation, are generally employed in combination with substances having a dispersing and/or emulsifying action, or are chemically modified accordingly.

In one preferred embodiment of the process of the invention drying accelerants are added as early as during the reaction of components a), b), c) and optionally d) to form an isocyanate-functional alkyd resin. Particular preference is given to the addition of drying accelerant during the two-stage preparation of the isocyanate-functional alkyd resin, after preparation of the isocyanate-functional reaction product of the first reaction stage from a), b) and c), before, together with or after, preferably after, the addition of component d), with subsequent reaction to give the isocyanate-functional alkyd resin, which is then chain-extended and is dispersed.

The alkyd resin dispersions of the invention have solids contents of 25% to 50% by weight and average particle sizes of 20 to 300, preferably of 30 to 200 nm.

The alkyd resin dispersions of the invention can be used in combination with further dispersions, such as polyacrylate dispersions, polyacrylate emulsions, other alkyd dispersions, polyurethane-polyacrylate dispersions, polyurethane dispersions, polyester dispersions, aqueous epoxy resins, polymer dispersions and/or in combination with crosslinker resins such as, for example, polyisocyanates optionally containing hydrophilic groups and containing free or blocked polyisocyanate groups, with polyaziridines, with amino crosslinker resins, based for example on melamine or urea.

Combination with optionally hydrophilicized polyisocyanates containing free isocyanate groups, based for example on trimers, urethanes, allophanates, uretdiones, iminooxadiazinediones and/or biurets of hexamethylene diisocyanate and/or of isophorone diisocyanate, leads to reactive two-component (2K) polyurethane systems having a pot life of several hours.

The present invention further provides binder combinations comprising the alkyd resin dispersions of the invention and crosslinker resins based on polyisocyanates and/or amino crosslinker resins.

Examples of groups suitable for hydrophilicizing polyisocyanates include polyethylene oxide chains and/or carboxylate or sulphonate groups, which via corresponding compounds containing hydroxyl and/or amino groups can be reacted with the polyisocyanate.

Preferred binder combinations are those of the alkyd resin dispersions of the invention and polyisocyanate crosslinkers containing free isocyanate groups.

Particularly preferred binder combinations are those of the alkyd resin dispersions of the invention and hydrophilicized polyisocyanate crosslinkers containing free polyisocyanate groups.

The present invention also provides for the use of the alkyd resin dispersions of the invention for producing transparent coatings, pigmented or unpigmented coatings on mineral or ceramic substrates and materials, concrete, hard fibre materials, metallic substrates, plastics, paper, card, composite materials, glass, porcelain, textile and/or leather. Preferred substrates are wooden and wood-like substrates such as, for example, furniture, wood fiberboard, wood-block flooring, window frames, doors, fences, panels, planks, beams or roofs.

### EXAMPLES

### I) Alkyd Resin 1)

In a 5 l reactor with stirrer, condenser and water separator, 466 g of phthalic anhydride, 460 g of adipic acid, 2651 soya oil fatty acid, 1266 g of trimethylolpropane and 2 g of Fascat® 4100 [butyltin oxide, Arkema, France] are weighed out, melted or homogenized, and heated to 190° C. while 5 l nitrogen/hour are passed through. Esterification is continued at this temperature, with elimination of water, until an acid number of <2.5 mg KOH/g has been reached. The batch is then cooled to 120° C. and dispensed into tin cans.

This gives the 100% alkyd resin 1) having a calculated functionality of 2.0, an OH number of 78 mg KOH/g, an acid number of 2.3 mg KOH/g and a calculated average molecular weight of 1428 g/mol.

### II) Alkyd Resin 2)

In a 5 l reactor with stirrer, condenser and water separator, 777 g of phthalic anhydride, 153 g of adipic acid, 2651 soya oil fatty acid, 1266 g of trimethylolpropane and 2 g of Fascat® 4100 are weighed out, melted or homogenized, and heated to 190° C. while 5 lnitrogen/hour are passed through. Esterification is continued at this temperature, with elimination of water, until an acid number of <2.5 mg KOH/g has been reached. The batch is then cooled to 120° C. and dispensed into tin cans.

This gives the 100% alkyd resin 2) having a calculated functionality of 2.0, an OH number of 77 mg KOH/g, an acid number of 2.2 mg KOH/g and a calculated average molecular weight of 1452 g/mol.

### III) Alkyd Resin 3)

In a 5 lreactor with stirrer, condenser and water separator, 470 g of phthalic anhydride, 292 g of adipic acid, 170 g of isophthalic acid, 2151 g of soya oil fatty acid, 500 g of peanut oil fatty acid, 1266 g of trimethylolpropane and 1.5 g of Fascat® 4100 are weighed out, melted or homogenized, and heated to 190° C. while 5 lnitrogen/hour are passed through. Esterification is continued at this temperature, with elimination of water, until an acid number of <2.5 mg KOH/g has been reached. The batch is then cooled to 120° C. and dispensed into tin cans.

This gives the 100% alkyd resin 3) having a calculated functionality of 2.0, an OH number of 78 mg KOH/g, an acid number of 2.2 mg KOH/g and a calculated average molecular weight of 1436 g/mol.

### IV) Alkyd Resin 4)

In a 15 lreactor with stirrer, condenser and water separator, 3718 g of isophthalic acid, 511 g of adipic acid, 7461 g of soya oil fatty acid, 3564 g of trimethylolpropane, 1019 g of neopentyl glycol and 2 g of Fascate® 4100 are weighed out, melted or homogenized, and heated to 190° C. while 15 l nitrogen/hour are passed through. Esterification is continued at this temperature, with elimination of water, until an acid number of <2.5 mg KOH/g has been reached. The batch is then cooled to 120° C. and dispensed into tin cans.

This gives the 100% alkyd resin 3) having a calculated functionality of 2.0, an OH number of 80 mg KOH/g, an acid number of 2.1 mg KOH/g and a calculated average molecular weight of 1418 g/mol.

PU-Alkyd Resin Dispersion 1): Prepolymer Two-Stage, Neutralization and CE in Org. Solution, Siccative, Dispersing in Water

In a 4 l reaction vessel with stirrer and reflux condenser, 306.2 g of alkyd resin 1), 19.1 g of dimethylolpropionic acid and 300 g of acetone are weighed out and homogenized. Subsequently a drop of Desmorapid® Z [dibutyltin dilaurate, Bayer MaterialScience AG, Leverkusen, Del.], 40.8 g of 2,4(2,6)-diisocyanatotoluene and 138.5 g of isophorone diisocyanate are added with stirring. This reaction mixture is stirred at 60° C. until the NCO value is <5.3%. Then 18.6 g of butanediol are added and the mixture is stirred until the NCO value is <3.0%. The batch is then diluted with 637 g of acetone, and 14.4 g of triethylamine are added in order to neutralize the carboxyl groups. Thereafter a mixture of 15.3 g of isophoronediamine, 5.4 g of ethylenediamine and 36.5 g of water is metered in over 5 minutes, followed by addition of 0.6 g of Octa-Soligen® Cobalt 7 aqua [cobalt siccative, Borchers GmbH, Germany. The stated amount of Octa-Soligen® Cobalt 7 aqua is always based on the active substance content of the siccative] are added and homogenized. After that, 920 g of distilled water are added and the acetone is distilled off. This gives the virtually solvent-free alkyd resin dispersion 1) of the invention, having a solids content of 36%, a pH of 7.8, and an average particle size of 149 nm.

PU-Alkyd Resin Dispersion 2): Prepolymer One-Stage, Neutralization and CE in Org. Solution, Siccative, Dispersing in Water

In a 4 l reaction vessel with stirrer and reflux condenser, 306.2 g of alkyd resin 1), 26.3 g of dimethylolpropionic acid, 14 g of butanediol and 300 g of acetone are weighed out and homogenized. Subsequently a drop of Desmorapid® Z and 204.2 g of isophorone diisocyanate are added with stirring. This reaction mixture is stirred at 60° C. until the NCO value is <4.1%. The batch is then diluted with 862 g of acetone, and 19.8 g of triethylamine are added in order to neutralize the carboxyl groups. Thereafter a mixture of 22.2 g of isophoronediamine, 5.9 g of ethylenediamine and 25.6 g of water is metered in over 5 minutes, followed by addition and homogenization of 2.2 g of Octa-Soligen® Cobalt 7 aqua. After that, 1250 g of distilled water are added and the acetone is distilled off. This gives the virtually solvent-free alkyd resin dispersion 2) of the invention, having a solids content of 30%, a pH of 8.3, and an average particle size of 95 nm.

PU-Alkyd Resin Dispersion 3): Prepolymer One-Stage, Neutralization and CE in Org. Solution, Siccative, Dispersing in Water

In a 4 l reaction vessel with stirrer and reflux condenser, 306.2 g of alkyd resin 1), 19.2 g of dimethylolpropionic acid, 18.5 g of butanediol and 300 g of acetone are weighed out and homogenized. Subsequently a drop of Desmorapid® Z and 191.8 g of isophorone diisocyanate are added with stirring. This reaction mixture is stirred at 60° C. until the NCO value is <3.6%. The batch is then diluted with 839 g of acetone, and 14.5 g of triethylamine are added in order to neutralize the carboxyl groups. Thereafter a mixture of 27.2 g of isophoronediamine, 2.4 g of ethylenediamine and 154.6 g of water is metered in over 5 minutes, followed by addition and homogenization of 0.6 g of Octa-Soligen® Cobalt 7 aqua. After that, 840 g of distilled water are added and the acetone is distilled off. This gives the virtually solvent-free alkyd resin dispersion 3) of the invention, having a solids content of 36%, a pH of 7.5, and an average particle size of 182 nm.

PU-Alkyd Resin Dispersion 4): Prepolymer Two-Stage, Neutralization and CE in Org. Solution, Siccative, Dispersing in Water

In a 4 l reaction vessel with stirrer and reflux condenser, 344.5 g of alkyd resin 1), 21.9 g of dimethylolpropionic acid and 440 g of acetone are weighed out and homogenized. Subsequently a drop of Desmorapid® Z, 45 g of 4,4′-diisocyanatodiphenylmethane and 175.8 g of isophorone diisocyanate are added with stirring. This reaction mixture is stirred at 60° C. until the NCO value is <4.6%. Then 18.5 g of butanediol are added and the mixture is stirred until the NCO value is <2.9%. The batch is then diluted with 640 g of acetone, and 16.5 g of triethylamine are added in order to neutralize the carboxyl groups. Thereafter a mixture of 12.2 g of isophoronediamine, 4.3 g of ethylenediamine and 93.8 g of water is metered in over 5 minutes, followed by addition and homogenization of 0.6 g of Octa-Soligen® Cobalt 7 aqua. After that, 860 g of distilled water are added and the acetone is distilled off. This gives the virtually solvent-free alkyd resin dispersion 4) of the invention, having a solids content of 38%, a pH of 8.2, and an average particle size of 211 nm.

### Test Results:

The PU-alkyd resin dispersions 1), 2), 3) and 4) are admixed with a 1:1 mixture of 8% butyl diglycol/water as coalescer and then clear varnishes are applied with a wet film thickness of 200 μm to glass plates, or 3 coats of 120 g/m² to wood, after which film drying takes place at room temperature or at 50° C. The test results obtained for the transparent coatings were as follows:

TABLE 1

| Alkyd resin dispersion | 1) | 2) | 3) | 4) |
|---|---|---|---|---|
| Wood discoloration | none | none | none | none |
| Film optical qualities | clear, homogeneous films with very good levelling | | | |
| Colour intensification after | very slight | moderate | slight | slight |
| curing | | | | |
| Sand drying at RT [min] | 38′ | 40′ | 40′ | 35′ |
| Full drying at RT [hours] | 1 h 55′ | 1 h 32′ | 1 h 30′ | 1 h 40′ |
| Film hardness after 1 day/ | 38″/88″/104″ | 49″/109″/112″ | 31″/95″/109″ | 31″/94″/101″ |
| 4 days/7 days of drying at RT | | | | |
| [pendulum sec.] | | | | |
| Ultimate film hardness | 104″ | 126″ | 116″ | 118″ |
| [pendulum seconds; after | | | | |
| 16 h drying at 50° C.] | | | | |
| Water resistance [24 h]; | 5 | 5 | 5 | 5 |
| rating 5 = nothing found; | | | | |
| rating 0 = dissolved | | | | |
| Ethanol resistance * [30 | 3 | 4 | 3 | 3 |
| min]; rating 5 = nothing | | | | |
| found; rating 0 = surface | | | | |
| destroyed | | | | |
| BHMR ** [rating 5 no | 4-5 | 4 | 4 | 4-5 |
| damage, 4 slight loss of | | | | |
| gloss, 3 slight abrasion, 2 | | | | |
| severe abrasion, 1 = surface | | | | |
| destroyed] | | | | |
| Adhesion [rating 5 = | 5 | 5 | 5 | 5 |
| excellent adhesion, rating 1 = | | | | |
| no adhesion] | | | | |

* Ethanol resistance:
The section of felt soaked with the test agent is placed onto the test area and covered with the screw lid. After the exposure time indicated in the test plan (5 and 30 minutes) the section of felt is removed and the test area is cleaned with a paper cloth and scratched with the fingernail.
The test area is immediately assessed on the following scale of ratings:
Rating 5: No visible changes (no damage).
Rating 4: Slight scratch marking or change in gloss or hue, visible only if the light source shines in the test surface on the mark or close to the mark, and is reflected directly to the eye of the viewer, or a few separate marks which are just perceptible.
Rating 3: Scratch marking on the surface or slight marking is visible from a number of viewing angles; for example, an almost complete circle or circular area just perceptible.
Rating 2: Severe marking; the surface structure is damaged, but the film is not all gone.
Rating 1: Severe marking; the surface structure is changed or the surface
material is partly destroyed or the filter paper sticks to the surface. In the case of scratching the film is removed (down to wood).
Rating 0: Very severe marking; the surface structure is changed or the
surface material is wholly or partly destroyed or the filter paper sticks to the surface.
** Black heel mark resistance: The surface is reproducibly stressed or damaged by a falling pendulum.

The alkyd resin dispersions of the invention are capable of meeting all of the requirements imposed. They can be prepared inexpensively and without complications, and in the as-supplied form they contain no organic solvent. Transparent coatings produced using them exhibit very good film formation, very good wood grain highlighting; they dry in less than 2 hours, and the films produced exhibit very good water resistance and ethanol resistance. The black heel mark resistance is likewise outstanding. The level of solvent needed for film formation is extremely low, and the nature of the solvent is freely selectable, depending on requirement.

PU-Alkyd Resin Dispersion 5): Prepolymer Two-Stage+Siccative, Neutralization and CE in Org. Solution, Dispersing in Water, Addition of CE

In a 15 l reaction vessel with stirrer and reflux condenser, 2160 g of alkyd resin 1), 139 g of dimethylolpropionic acid and 2100 g of acetone are weighed out and homogenized. Subsequently 100 ppm of Desmorapid® Z, 283 g of 2,4(2,6)-diisocyanatotoluene and 982 g of isophorone diisocyanate are added with stirring. This reaction mixture is stirred at 55° C. until the NCO value is <5.2%. Then 139 g of butanediol and 5 g of Octa-Soligen® Cobalt 7 aqua siccative are added and the mixture is stirred until the NCO value is <2.8%. The batch is then diluted with 280 g of acetone, and 104 g of triethylamine are added in order to neutralize the carboxyl groups. Thereafter a mixture of 24.6 g of ethylenediamine, 69.7 g of isophoronediamine and 395 g of water is metered in over 5 minutes, and then dispersion is carried out by addition of 5600 g of water. After the dispersing operation, a mixture of 34.9 g of isophoronediamine, 12.3 g of ethylenediamine and 198 g of water is metered in, the mixture is stirred for 15 minutes, and then the acetone is distilled off under a gentle vacuum. This gives the virtually solvent-free alkyd resin dispersion 5) of the invention, having a solids content of 38%, a pH of 7.9, and an average particle size of 110 nm.

PU-Alkyd Resin Dispersion 6): Prepolymer Two-Stage+Siccative, Neutralization and CE in Org. Solution, Dispersing in Water+CE

In a 4 l reaction vessel with stirrer and reflux condenser, 208 g of alkyd resin 1), 206 g of alkyd resin 4), 26.5 g of dimethylolpropionic acid and 400 g of acetone are weighed out and homogenized. Subsequently 100 ppm of Desmorapid® Z, 54.2 g of 2,4(2,6)-diisocyanatotoluene and 188 g of isophorone diisocyanate are added with stirring. This reaction mixture is stirred at 55° C. until the NCO value is <5.2%. Then 26.7 g of butanediol and 2.9 g of Octa-Soligen® 144 aqua [cobalt-containing siccative; Borchers GmbH, Germany] are added and the mixture is stirred until the NCO value is <2.86%. The batch is then diluted with 430 g of acetone, and 20 g of triethylamine are added in order to neutralize the carboxyl groups. Thereafter a mixture of 4.7 g of ethylenediamine, 13.3 g of isophoronediamine and 75.6 g of water is metered in over 5 minutes, and subsequently the acetonic polymer solution is dispersed in a mixture of 1098 g of water, 6.7 g of isophoronediamine and 2.4 g of ethylenediamine, the mixture is stirred for 15 minutes, and then the acetone is distilled off under a gentle vacuum. This gives the virtually solvent-free alkyd resin dispersion 6) of the invention, having a solids content of 37%, a pH of 7.8, and an average particle size of 135 nm.

Dispersions 5) and 6) are diluted with water to a solids content of 35% and are applied with a wet film thickness of 200 μm to glass, to black-coloured Plexiglas and, in an amount of 3×120 g/m², to oak boards. The films are subjected to forced drying at 50° C. for 16 h. The test results obtained are as follows:

TABLE 2

| PU-alkyd resin dispersion | 5) | 6) |
|---|---|---|
| Discoloration of the wood by the varnish | none | none |
| Film optical qualities (glass) | smooth, very good | |
| | levelling | |
| Film optical qualities (Plexiglas) | clear, no hazing | |
| Gardner gloss (Plexiglas) 20°/60° | 84/90 | 83/91 |
| Gardner haze factor | 30 | 33 |
| Pendulum hardness | 92″ | 124″ |
| Water resistance [24 h exposure; rating 5 = | 5 | 5 |
| nothing found; rating 1 = dissolved] | | |
| Ethanol resistance [30 minute exposure, | 5 | 5 |
| subsequent recovery of the film; rating 5 = | | |
| nothing found, rating 3 = reversible softening; | | |
| rating 1 = dissolved] | | |
| Adhesion [rating 5 = excellent adhesion, rating | 5 | 5 |
| 1 = no adhesion] | | |

The films have very good mechanical and resistance properties, and the film optical values are likewise very good.

PU-Alkyd Resin Dispersion 7): Prepolymer Two-Stage+Siccative, Neutralization and CE in Org. Solution, Dispersing in Water, Addition of CE

In a 4 l reaction vessel with stirrer and reflux condenser, 429.6 g of alkyd resin 2), 26.5 g of dimethylolpropionic acid and 415 g of acetone are weighed out and homogenized. Subsequently 75 ppm of Desmorapid® Z, 54.2 g of 2,4(2,6)-diisocyanatotoluene and 188 g of isophorone diisocyanate are added with stirring. This reaction mixture is stirred at 55° C. until the NCO value is <5.1%. Then 26.7 g of butanediol and 0.75 g of Octa-Soligen® Cobalt 7 aqua are added and the mixture is stirred until the NCO value is <2.8%. The batch is then diluted with 447 g of acetone, and 20 g of triethylamine are added in order to neutralize the carboxyl groups. Thereafter a mixture of 4.8 g of ethylenediamine, 13.5 g of isophoronediamine and 76 g of water is metered in over 5 minutes, and subsequently the acetonic polymer solution is dispersed in 1080 g of water and subsequently a mixture of 6.7 g of isophoronediamine, 2.4 g of ethylenediamine and 51 g of water is metered in and then the acetone is distilled off under a gentle vacuum. This gives the virtually solvent-free alkyd resin dispersion 7) of the invention, having a solids content of 38%, a pH of 8.4, and an average particle size of 150 nm.

PU-Alkyd Resin Dispersion 8): Prepolymer Two-Stage+Siccative, Neutralization and CE in Org. Solution, Dispersing in Water, Addition of CE

In a 4 l reaction vessel with stirrer and reflux condenser, 435 g of alkyd resin 3), 26.5 g of dimethylolpropionic acid and 415 g of acetone are weighed out and homogenized. Subsequently 75 ppm of Desmorapid® Z, 54.2 g of 2,4(2,6)-diisocyanatotoluene and 188 g of isophorone diisocyanate are added with stirring. This reaction mixture is stirred at 65° C. until the NCO value is <5.0%. Then 26.7 g of butanediol and 0.75 g of Octa-Soligen® Cobalt 7 aqua are added and the mixture is stirred until the NCO value is <2.7%. The batch is then diluted with 451 g of acetone, and 20 g of triethylamine are added in order to neutralize the carboxyl groups. Thereafter a mixture of 4.8 g of ethylenediamine, 13.5 g of isophoronediamine and 76 g of water is metered in over 5 minutes, and subsequently the acetonic polymer solution is dispersed in 1080 g of water and subsequently a mixture of 6.7 g of isophoronediamine, 2.4 g of ethylenediamine and 51 g of water is metered in and then the acetone is distilled off under a gentle vacuum. This gives the virtually solvent-free alkyd resin dispersion 8) of the invention, having a solids content of 38%, a pH of 8.2, and an average particle size of 103 nm.

PU-Alkyd Resin Dispersion 9): Prepolymer Two-Stage+Siccative, Neutralization and CE in Org. Solution, Dispersing in Water, Addition of CE

In a 4 l reaction vessel with stirrer and reflux condenser, 435 g of alkyd resin 1), 26.5 g of dimethylolpropionic acid and 406 g of acetone are weighed out and homogenized. Subsequently 75 ppm of Desmorapid® Z, 119.7 g of 2,4(2,6)-diisocyanatotoluene, 52.6 g of isophorone diisocyanate and 59.0 g of 4,4′-diisocyanatodicyclohexylmethane are added with stirring. This reaction mixture is stirred at 65° C. until the NCO value is <5.2%. Then 26.7 g of butanediol and 0.75 g of Octa-Soligen® Cobalt 7 aqua are added and the mixture is stirred until the NCO value is <2.8%. The batch is then diluted with 438 g of acetone, and 20 g of triethylamine are added in order to neutralize the carboxyl groups. Thereafter a mixture of 4.8 g of ethylenediamine, 13.5 g of isophoronediamine and 76 g of water is metered in over 5 minutes, and subsequently the acetonic polymer solution is dispersed in 1056 g of water and subsequently a mixture of 6.7 g of isophoronediamine, 2.4 g of ethylenediamine and 51 g of water is metered in and then the acetone is distilled off under a gentle vacuum. This gives the virtually solvent-free alkyd resin dispersion 9) of the invention, having a solids content of 38%, a pH of 8.3, and an average particle size of 200 nm.

PU-Alkyd Resin Dispersion 10): Prepolymer Two-Stage+Siccative, Neutralization and CE in Org. Solution, Dispersing in Water, Addition of CE

In a 4 l reaction vessel with stirrer and reflux condenser, 334 g of alkyd resin 1), 24.9 g of dimethylolpropionic acid and 362 g of acetone are weighed out and homogenized. Subsequently 75 ppm of Desmorapid® Z, 56.1 g of 2,4(2,6)-diisocyanatotoluene and 195.4 g of isophorone diisocyanate are added with stirring. This reaction mixture is stirred at 65° C. until the NCO value is <6.8%. Then 35.6 g of butanediol and 0.72 g of Octa-Soligen® Cobalt 7 aqua are added and the mixture is stirred until the NCO value is <3.2%. The batch is then diluted with 391 g of acetone, and 18.8 g of triethylamine are added in order to neutralize the carboxyl groups. Thereafter a mixture of 4.8 g of ethylenediamine, 13.5 g of isophoronediamine and 76 g of water is metered in over 5 minutes, and subsequently the acetonic polymer solution is dispersed in 951 g of water and subsequently a mixture of 6.7 g of isophoronediamine, 2.4 g of ethylenediamine and 51 g of water is metered in and then the acetone is distilled off under a gentle vacuum. This gives the virtually solvent-free alkyd resin dispersion 10) of the invention, having a solids content of 37.7%, a pH of 8.2, and an average particle size of 124 nm.

Dispersions 7) to 10) are applied and cured as described above. All of the dispersions dry in less than 2 hours at room temperature to give clear, homogeneous films having very good levelling and free from disruptive discoloration. The test results obtained were as follows:

TABLE 3

| Alkyd resin dispersion | Disp. 7) | Disp. 8) | Disp. 9) | Disp. 10) |
|---|---|---|---|---|
| Film hardness after 1 day/4 | 63″/78″/104″ | 52″/64″/84″ | 39″/57″/96″ | 74″/105″/109″ |
| days/ | | | | |
| 7 days of drying at RT | | | | |
| [pendulum seconds] | | | | |
| Ultimate film hardness | 112″ | 100″ | 108″ | 116″ |
| [pendulum seconds; after 16 h of | | | | |
| drying at 50° C.] | | | | |
| Water resistance [24 h]; rating | 5 | 5 | 5 | 5 |
| 5 = nothing found; rating 0 = | | | | |
| dissolved] | | | | |
| Ethanol resistance * [30 min]; | 5 | 5 | 5 | 5 |
| rating 5 = nothing found, rating | | | | |
| 0 = surface destroyed | | | | |
| BHMR [rating 5 no damage, | 4 | 4 | 4-5 | 3-4 |
| 4 slight loss of gloss, 3 slight | | | | |
| abrasion, 2 severe abrasion, | | | | |
| 1 = surface destroyed] | | | | |
| Gloss on black Plexiglas | 84 | 84 | 86 | 83 |
| (20° Gardner gloss) | | | | |
| Adhesion [rating 5 = excellent | 5 | 5 | 5 | 5 |
| adhesion, rating 1 = no | | | | |
| adhesion] | | | | |

Transparent coatings produced with these dispersions exhibit very good film formation, very good wood grain highlighting and high gloss values; they dry in less than 2 hours, and the films produced exhibit very good water resistance and ethanol resistance. The black heel mark resistance is at a high level. The amount of solvent required for film formation is low, and the nature of the solvent is freely selectable, depending on the profile of requirements.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. Aqueous polyurethane (PU)-alkyd resin dispersions comprising reaction products of
a) at least one alkyd resin incorporating at least 40% by weight of fatty acids that undergo oxidative crosslinking upon exposure to atmospheric oxygen,
b) at least one at least difunctional polyisocyanate,
c) at least one carboxy/carboxylate-functional and hydroxy- or amino-functional hydrophilicizing agent,
d) optionally diols and/or triols of the molecular weight range 62 to 600 and
e) at least one diamine, optionally in combination with a triamine and/or amino alcohol.

2. Aqueous polyurethane (PU)-alkyd resin dispersion according to claim 1, further comprising as a reaction component
f) at least one component selected from the group consisting of monohydroxy-functional ethylene oxide polyethers, monohydroxy-functional propylene oxide/ethylene oxide copolyethers, monohydroxy-functional propylene oxide/ethylene oxide block polyethers, any of the preceding polyethers being of the molecular weight range 200 to 3000 g/mol, monoalcohols, monoamines and mixtures thereof.

3. Aqueous polyurethane (PU)-alkyd resin dispersions according to claim 1, wherein the ratio of fatty acid groups (MW 280 g/mol) to urethane groups (MW 59 g/mol) is 1:1.5 to 4.5.

4. Aqueous polyurethane (PU)-alkyd resin dispersions according to claim 1, wherein the alkyd resin a) present as synthesis component has an acid number of 6 to 1 mg KOH/g and is a reaction product of
a1) at least one dicarboxylic and/or tricarboxylic acid and/or anhydride thereof,
a2) at least one di-, tri- and/or tetraol, preferably at least one triol,
a3) at least one monocarboxylic acid, composed of at least 90% by weight of fatty acids containing double bonds that undergo oxidative crosslinking upon exposure to atmospheric oxygen.

5. Aqueous polyurethane(PU)-alkyd resin dispersions according to claim 1, wherein the polyisocyanate component b) contains at least 30% to 95% by weight of cycloaliphatic diisocyanates and 5% to 70% by weight of aromatic di- and/or polyisocyanates.

6. Aqueous polyurethane(PU)-alkyd resin dispersions according to claim 1, wherein component e) comprises a mixture of at least one linear-aliphatic diamine and/or triamine e1) and at least one cycloaliphatic diamine e2).

7. Process for preparing the aqueous PU-alkyd resin dispersions according to claim 1, wherein components a) to d) and optionally f) are reacted in one or more reaction steps to give an isocyanate-functional alkyd resin, with solvents and neutralizing agents being added before, during and/or after the reaction, then a chain extension is carried out with component e) in organic solution, and subsequently dispersion is carried out in or with water.

8. Process for preparing the aqueous PU-alkyd resin dispersions according to claim 7, wherein components a) to d) and optionally f) are reacted in one or more reaction steps to give an isocyanate-functional alkyd resin, with solvents being added before, during or after the reaction and the neutralizing agent being added during or after the reaction, subsequently a first chain extension is carried out with a portion of component e) in organic solution and then a second chain extension is carried out with the remainder of component e), during or after the dispersing step, the quantitative ratio of the components e) used in the first and in the second chain extension steps being 0.3:1 to 6:1.

9. Process for preparing the aqueous PU-alkyd resin dispersions according to claim 7, wherein the solvent is separated off by distillation during or after the dispersing step.

10. Process for preparing aqueous PU-alkyd resin dispersions according to claim 7, wherein drying accelerants are added.

11. Binder combinations comprising aqueous PU-alkyd resin dispersions according to claim 1 and crosslinker resins based on polyisocyanates and or amino crosslinker resins.

12. Transparent, pigmented or unpigmented coatings comprising the aqueous PU-alkyd resin dispersions according to claim 1.

13. A mineral, ceramic, concrete, hard fibre, metallic, plastic, paper, card, composite, glass, porcelain, textile and/or leather substrate coated with the coating of claim 12.

14. Aqueous polyurethane(PU)-alkyd resin dispersions according to claim 4, wherein the alkyd resin a) present as synthesis component is a reaction product of a mixture of a11) at least one aromatic dicarboxylic acid and/or its anhydride and a12) at least one linear, aliphatic dicarboxylic acid.
